(19) United States
(12) Patent Application Publication
(10) Pub. No.: US 2015/0060101 A1
(43) Pub. Date: Mar. 5, 2015

(54) ELECTRICAL SHOCK AND BURN PROTECTION SYSTEM

(71) Applicant: Bruce H. Turner, Palo Alto, CA (US)

(72) Inventor: Bruce H. Turner, Palo Alto, CA (US)

(21) Appl. No.: 14/477,722

(22) Filed: Sep. 4, 2014

Related U.S. Application Data
(60) Provisional application No. 61/874,004, filed on Sep. 5, 2013.

(51) Int. Cl. H02G 3/08

(52) U.S. Cl. CPC H02G 3/081
USPC 174/66

(57) ABSTRACT

A cover for an electrical connector device of the type having exposed conductive screws that may have an electrical potential. The screws on each side of the device have screw heads nominally all in at least one respective screws head plane. The cover comprises an electrically insulating shroud retainedly fixable to the device to be planarly disposed over the at least one screws head plane such that the screws are thus not exposed.

### CROSS-REFERENCE TO RELATED APPLICATIONS

Not applicable.

STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Technical Field

The present invention relates generally to electrical connecting and switching apparatus, and more particularly to such comprising at least two electrically conducting elements.

2. Background Art

Today we rely heavily on electricity. Our homes and workspaces now have ubiquitous electricity distribution endpoints, controls, and sub distribution systems. For example, in North America the overwhelmingly encountered electricity distribution endpoint is the 3-prong, 120 volt alternating current (AC) duplex receptacle. There are present in most rooms in our residences as well as many other places such as in our offices, factories, and workshops. Throughout the rest of the world, directly analogous systems are used, albeit often supplying 240 volts AC.

An example of an electricity distribution control is the single pole toggle or rocker wall switch. In residences these are commonly used to turn lights on and off, wherein the lights may be permanently installed or temporarily plugged into a receptacle to which power is controlled by the switch. Of course, such switches can also be used to control many other electrical loads. Multi-pole switches and special switches to permit multi-point control (e.g., 3-way switches) are also common.

An example of an electricity sub distribution system is a breaker box. For instance, single-family residences typically each have such a breaker box, often also called a “service” where power is received into a single “main” or “mains” breaker, then routed into multiple individual circuit breakers, and from each of these distributed to endpoint receptacles and/or controls. Another example here is relays. The residential use of relays to distribute 120 or 240 volt AC power is less widely appreciated, but is common to power motors in water pumps, air conditioning, heating systems, etc. In contrast, commercial and industrial systems widely use relays for these and even higher voltages.

FIG. 1 (background art) shows a typical North America type 3-prong duplex receptacle assembly. These are constructed into or onto a wall (not shown; power wiring to the assembly is also not shown here). The receptacle 2 is housed in a junction box 3 and is partially covered with a cover plate 4.

FIG. 2 (background art) shows the same receptacle 2 as in FIG. 1, only with the cover plate 4 removed. Although the cover plate 4 is desirable for safety, many readers doubtless recall occasionally seeing receptacles 2 without cover plates 4. The cover plate 4 can be left off during initial construction, taken off and not replaced later, fall off, or be broken off. When this happens, wiring screws 5 on the receptacle 2 are exposed. As can be seen in FIG. 2, the wiring screws 5 there are in relatively close proximity to the sides of the junction box 3. This closeness of components is frequently the case in a junction box 3.

A junction box 3 can be a conductive type, made of metal, or it can be an insulating type, made of a non-conductive plastic. The junction box 3 in FIG. 2 is a commonly encountered metal type. When a junction box 3 is conductive, standard practice is to “bond” it to the system electrical ground.

FIGS. 3a-b (background art) show the same receptacle 2 as in FIGS. 1-2 from different angles and without the cover plate 4 and junction box 3, to illustrate one common scheme of attaching power wiring to the wiring screws 5. FIGS. 3a-b also show the front face of the receptacle 2, where it can be seen that this receptacle 2 has two receptacle outlets 2a-b that each may provide power. Each such receptacle outlet 2a-b has openings to receive three prongs: a hot opening 6a for a blade-shaped prong, a neutral opening 6b for a larger blade-shaped prong, and a ground opening 6c for a pin-shaped prong. The wiring screws 5 here include hot screws 5a (usually gold colored), neutral screws 5b (usually silver colored), and a ground screw 5c (usually green colored).

Inside the receptacle 2, the hot screws 5a each connect to respective conductors accessible via one of the hot openings 6a; the neutral screws 5b each connect to respective conductors accessible via one of the neutral openings 6b; and the ground screw 5c connects to respective conductors accessible via one of the ground openings 6c. The ground screw 5c also connects to the frame or bracket 9 of the receptacle 2, which holds the receptacle 2 in place in the junction box 3.

The two hot screws 5a are initially “bonded” together by a hot bond tab 7a. Similarly, the two neutral screws 5b are initially “bonded” together by a neutral bond tab 7b. Neither, either, or both of the hot bond tab 7a and the neutral bond tab 7b can be removed for different wiring schemes related to isolating or making common the receptacle outlets 2a-b.

Continuing with FIGS. 3a-b, a hot wire 8a is shown connected to one of the hot screws 5a. Since the hot bond tab 7a has not been removed here, the hot wire 8a, the hot screws 5a, and the conductors accessed via the hot openings 6a should all have the same electrical potential (i.e., potentially the hot potential). Similarly, a neutral wire 8b is connected to one of the neutral screws 5b. Since the neutral bond tab 7b has also not been removed here, the neutral wire 8b, the neutral screws 5b, and the conductors accessed via the neutral openings 6b should all have the same electrical potential (i.e., if properly wired, the neutral potential, which should effectively also be the ground potential because all neutral wires 8b should ultimately be bonded to ground at the electrical service). A ground wire 8c is also connected to the ground screw 5c, and hence the ground wire 8c and the conductors accessed via the ground openings 6c should all have the same electrical potential (i.e., ground potential).

In North America one wire color scheme is used and elsewhere, e.g., Europe, other schemes are used. Nonetheless, the point of such schemes is to inform which wire or wires are likely to have high potential (120 volts AC or higher), neutral potential (nominally 0 volts), and ground potential (0 volts).

With continued reference to FIGS. 3a-b and again to FIG. 2, some safety concerns are now discussed. Depending on the mains power being on, any intervening switches being closed, the receptacle 2 being wired as shown, and all else also being proper, the hot wire 8a will be at high electrical potential (120 volts AC in this style receptacle). A user touching a hot screw 5a now can receive an electrical shock and/or burn in any of various manners.

If the user touches a hot screw 5a and nothing else at the receptacle 2, power may still flow through the user to anything else they touch, e.g., the earth or floor on which they are standing. The extent of any shock or burn here will depend on the conductivity posed by the user and whatever they are touching, and thus to the ground for the circuit including the hot screw 5a.

If the user touches a hot screw 5a and also a neutral screw 5b, the likelihood of a shock and/or burn is high, with the extent depending on the conductivity posed by the user between the hot screw 5a and the neutral screw 5b. If the user touches the respective screws with opposite hands they may even receive a fatal shock, since the current path will be through one arm, across the torso and across the heart, and through the other arm. Similarly, if the user touches a hot screw 5a and also the ground screw 5c, the likelihood of and the extent of a shock and/or burn is essentially the same.

Next, recall that it was previously noted that it is standard practice to bond a metal junction box 3 to ground. Accordingly, if the user touches a hot screw 5a and such a metal junction box 3, the likelihood of and the extent of a shock and/or burn is essentially the same as the ground screw case. Note again the proximity of the hot screws 5a to the wall of the junction box 3. If the user gets a finger between these, at least a painful shock is virtually certain and a deep burn and/or nerve damage to the finger is quite possible. Unfortunately, this is a way that children sometimes learn that electricity is dangerous.

The above examples presumed proper wiring of the receptacle 2; let us now consider the alternative. When something is improper in the wiring at the receptacle 2, in the wiring to the receptacle 2, and/or in the wiring of a load powered from the receptacle 2, a neutral screw 5b can be just as dangerous as a hot screw 5a. Accordingly, it is a prudent safety practice to treat neutral screws 5b the same as hot screws 5a.

FIG. 4 (background art) shows a back view of the same receptacle 2 as in FIGS. 1-2, only when the receptacle 2 is new and before any wires have been attached to it. Here it can be seen that the wiring screws 5 on the receptacle 2 are usually not screwed in when the receptacle 2 is new. This saves time during installation, since a wiring screw 5 need not be screwed outwards to put a wire 8a-c under its respective wiring screw 5a-c. Here it can also be seen that the receptacle 2 has push-in mechanisms 10 to permit attachment of the hot and neutral wires, but not of the ground wire. Up to two each of the hot wires and the neutral wires may be attached to the receptacle using the push-in mechanisms 10, thus often permitting the hot screws 5a and the neutral screws 5b to simply not be used at all. When this is done, these screws 5a-b are often left as shown here, that is, not screwed in. Nonetheless, these screws 5a-b are still electrically common with the respective hot and neutral wires that are installed. Such not screwed in, sticking out screws 5a-b are therefore even more exposed and able to be safety hazards.

FIG. 5 (background art) shows an example of a typical North America type single-pole wall switch assembly. These are constructed into or onto a wall (not shown; power wiring to the assembly is also not shown here). The switch 12 is housed in a junction box 13 and is partially covered with a cover plate 14.

FIG. 6 (background art) shows the same switch 12 as in FIG. 5, only with the cover plate 14 removed. Here as well, the cover plate 14 is desirable for safety, to prevent wiring screws 15 on the switch 12 being exposed. And also here as well, the wiring screws 15 are in relatively close proximity to the junction box 13 and we again have a commonly encountered metal type wherein standard practice is to “bond” the junction box 13 to ground.

FIGS. 7a-b (background art) shows the same switch 12 as in FIGS. 5-6 from different angles and without the cover plate 14 and junction box 13, to illustrate one common scheme of attaching power wiring to the wiring screws 15. Briefly, the switch 12 here has a hot screw 15a, a switch leg screw 15b, and a ground screw 15c. The hot screw 15a receives a hot wire 18a, the switch leg screw 15b receives a switch leg wire 18b, and the ground screw 15c may receive a ground wire 18c. The switch 12 further has a bracket 19 that holds it in place in the junction box 13.

FIG. 8 (background art) shows a back view of the same switch 12 as in FIGS. 5-6, only when the switch 12 is new and before any wires have been attached to it. Similar to the case for the receptacle 2, the wiring screws 15 on the switch 12 are usually not initially screwed in and the switch 12 has push-in mechanisms 20 to permit attachment of the hot wire 18a and the switch leg wire 18b, but not a ground wire 18c. Here as well, such not screwed in, sticking out screws 15a-b are therefore even more exposed and able to be safety hazards.

Of course, various mechanisms are used to reduce the danger at wiring screws. For example, electrical devices can be constructed to make contact with a wiring screw very difficult. Breakers for use with smaller gauge wire (e.g., #12 and #14 AWG, or 2.5 mm), especially in household breaker boxes, are today built with additional plastic insulating material that extends outward so that a typical finger cannot touch a wiring screw. Breakers for use with larger gauge wire, and thus usually for higher currents, similarly have added material and designs to minimize danger.

Smaller and more numerous electrical devices, such as receptacles 2 and switches 12, are more problematical. For example, it is desirable to keep these devices small, to use long standardized sizes, and as economical as possible. Adding insulating material in the manner used to increase the safety of a breaker, for instance, would undermine at least two of these goals here. For these reasons, safety mechanisms usually should conform with current standard sizes and shapes, and minimally increase cost.

The overwhelming safety mechanism used on receptacles 2 and switches 12 today is having the person installing or servicing the device wrap insulating tape around the sides of the device to cover the wiring screws 5, 15. But this mechanism has a number of problems. First, many people simply do not do it. Initial installers and/or their employers usually resent the added time this takes. People servicing such devices may not think of this if the device was not initially taped up, or they may not have new tape handy for this purpose. Even if a person does tape a device, the result may still leave some high potential points exposed. For instance, wrapping the tape while avoiding screws in the device mounting bracket 9, 19 is difficult and, even when tape is applied, the hot bond tab 7a and the neutral bond tab 7b of a receptacle 2 tend to stick out.

Other than taping and the present invention, the only system that the present inventor is aware of is the use of hinged screw covers as shown in FIG. 9a-c (prior art). Unfortunately, these also have a number of disadvantages. They are expensive, since no original equipment manufacturer appears to have adopted them. They are also time consuming to install and difficult to install, albeit due to a well intended safety mechanism that the manufacturers of receptacles 2 and switches 12 do include in their products. These electrical devices, and some others, have wiring screws 5, 15 with specially altered threads. Such a wiring screw 5, 15 can be screwed inward from or outward to its original position, but not easily screwed all of the way out because the end threads of the male screw are altered to interfere with the corresponding female threads of the device that receive the screws. This prevents such a wiring screw 5, 15 from vibrating loose, say, if it is not being used to retain a wire and has not been tightened. This also prevents a wiring screw 5, 15 from falling off and being lost or falling into and shorting out other circuitry. Once such a wiring screw 5, 15 is forcibly removed, however, which usually is possible if enough force is used, reinserting and tightening the wiring screw 5, 15 can then be especially difficult.

It follows that there remains a need for additional safety mechanisms for electricity distribution endpoints, controls, and sub distribution systems. Such mechanisms should preferably be able to conform closely with existing device standards; should preferably be economical in both materials used and installation labor; and should preferably also be available from device original equipment manufacturers (OEMs) and as aftermarket options that are available to device installation and service industries.

### BRIEF SUMMARY OF THE INVENTION

Accordingly, it is an object of the present invention to provide an electrical shock and burn protection system.

Briefly, one preferred embodiment of the present invention is a cover for an electrical connector device of the type having exposed conductive screws that may have an electrical potential. The screws on the left and right or only the right side of the device have screw heads nominally occupying at least one respective screws head plane. The cover comprises an electrically insulating shroud retainedly fixable to the device to be planarly disposed over the at least one screws head plane such that the screws are not exposed.

Briefly, another preferred embodiment of the present invention is a method for protecting against shock or burn at an electrical connector device of the type having exposed conductive screws that may have an electrical potential. The screws have screw heads nominally defining at least one screws head plane. The device is defined to have a left side, a front face, a back face, and a right side. An electrically insulating shroud is formed having three sections defined by two right angle folds such that said shroud can cover the screws and the head plane of said left side and cover the screws and the head plane of said right side by enveloping the electrical connector device within said three sections. And the shroud is retainedly fixable attached to the device to be planarly disposed over the at least one screws head plane such that the screws are not exposed.

Briefly, another preferred embodiment of the present invention is a method for protecting against shock or burn at an electrical connector device of the type having exposed conductive screws that may have an electrical potential. The screws have screw heads nominally defining a screws head plane. The device is defined to have a left side, a front face, a back face, and a right side, wherein the screws head plane is at said right side. An electrically insulating shroud is formed having two major sections defined by a fold such that the shroud can cover the screws and the head plane of the right side. And the shroud is retainedly fixable attached to the device to be planarly disposed over the screws head plane such that the screws are not exposed.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1 (background art) shows a typical North America type 3-prong duplex receptacle assembly.

FIG. 2 (background art) shows the same receptacle as in FIG. 1, only with the cover plate 4 removed.

FIGS. 3a-b (background art) show the same receptacle as in FIGS. 1-2 from different angles and without the cover plate and junction box, to illustrate one common scheme of attaching power wiring to the wiring screws.

FIG. 4 (background art) shows a back view of the same receptacle as in FIGS. 1-2, only when the receptacle is new and before any wires have been attached to it.

FIG. 5 (background art) shows an example of a typical North America type single-pole switch assembly.

FIG. 6 (background art) shows the same switch as in FIG. 5, only with the cover plate removed.

FIGS. 7a-b (background art) show the same switch as in FIGS. 5-6 from different angles and without the cover plate and junction box, to illustrate one common scheme of attaching power wiring to the wiring screws.

FIG. 8 (background art) shows a back view of the same switch as in FIGS. 5-6, only when the switch is new and before any wires have been attached to it.

FIG. 9a-c (prior art) show different views of a hinged screw cover.

FIGS. 10a-b depict an example of a full butterfly style cover in accord with the present invention, specifically a type designed for aftermarket mounting on a receptacle.

FIGS. 11a-b depict an example of a half butterfly style cover in accord with the present invention, specifically a type designed for aftermarket mounting on a receptacle.

FIGS. 12a-b depict an example of an alternate full butterfly style cover in accord with the present invention, specifically a type designed for aftermarket mounting on a switch.

FIGS. 13a-b depict an example of an alternate half butterfly style cover in accord with the present invention, specifically a type designed for aftermarket mounting on a switch.

FIG. 14 depicts an example of an alternate full butterfly style cover in accord with the present invention, specifically a type designed for OEM installation as part of a receptacle.

FIG. 15 depicts an example of an alternate half butterfly style cover in accord with the present invention, specifically a type designed for OEM installation as part of a switch.

FIGS. 16a-d show the full butterfly style cover of FIGS. 10a-b respectively in a front finished view, a front flat unfinished view, an isometric finished view, and a front isometric unfinished view.

FIGS. 17a-d show the half butterfly style cover of FIGS. 11a-b in the same views.

FIGS. 18a-d show the full butterfly style cover of FIGS. 12a-b in the same views.

FIGS. 19a-d show the half butterfly style cover of FIGS. 13a-b in the same views.

FIGS. 20a-d show the full butterfly style cover of FIG. 14 in the same views.

FIGS. 21a-d show the half butterfly style cover of FIG. 15 in the same views.

FIGS. 22a-b show the cover of FIGS. 10a-b in isometric and top views.

FIGS. 23a-b show a slight variation of the cover of FIGS. 10a-b in isometric and top views.

FIG. 24 shows a front view of another variation of the cover of FIGS. 10a-b installed on a receptacle.

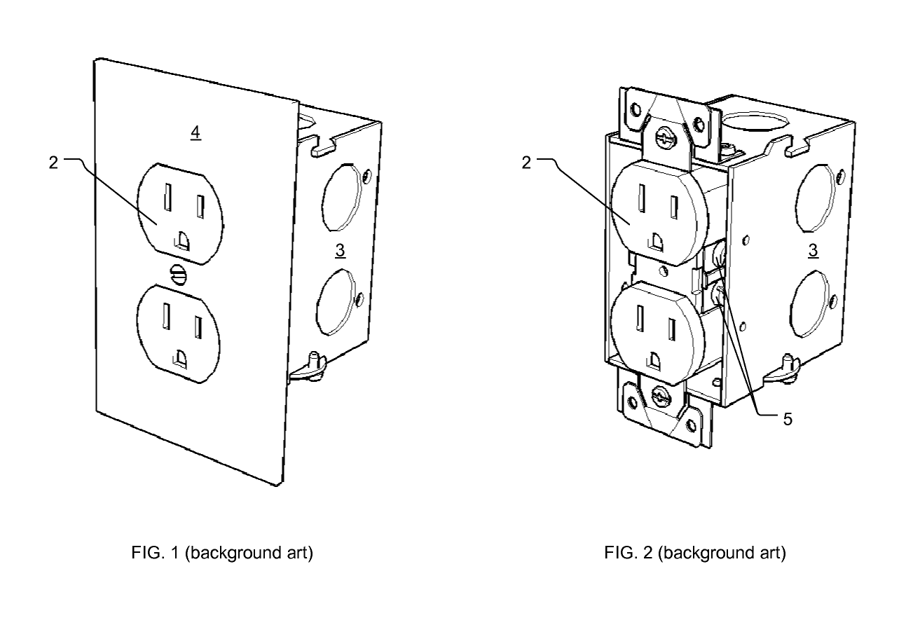

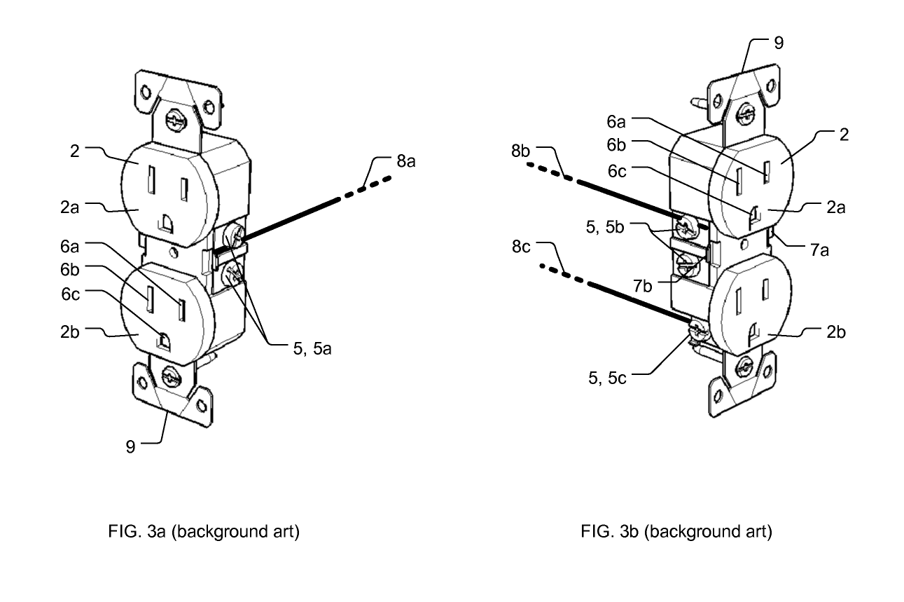

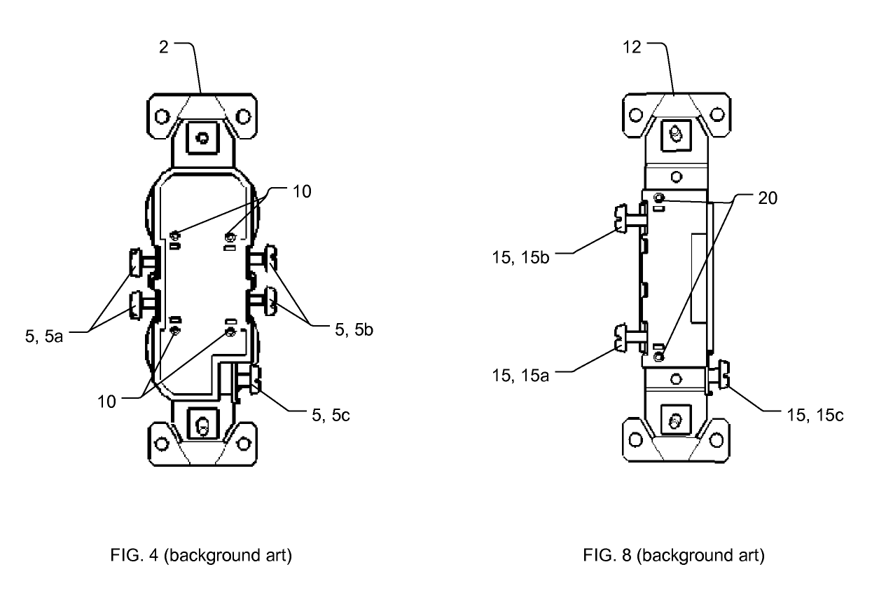

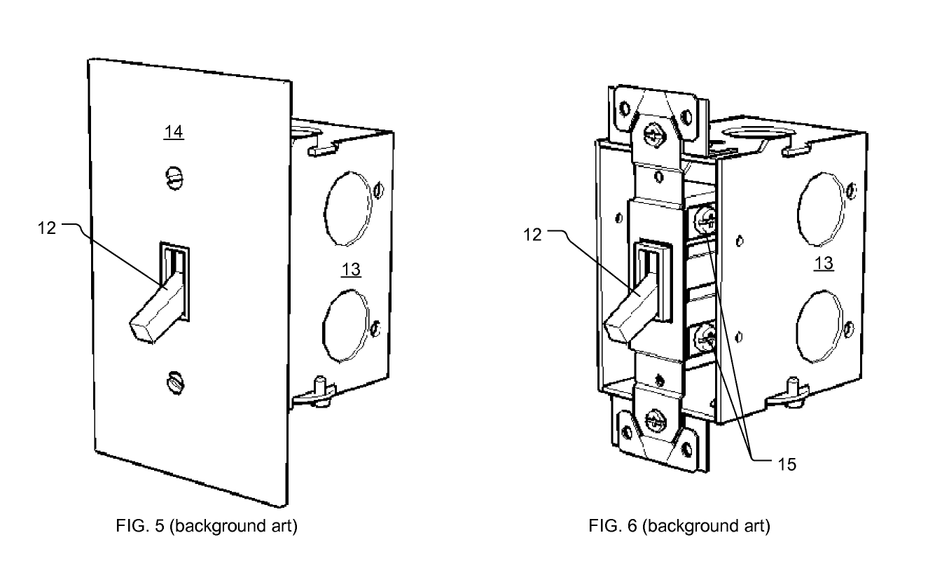

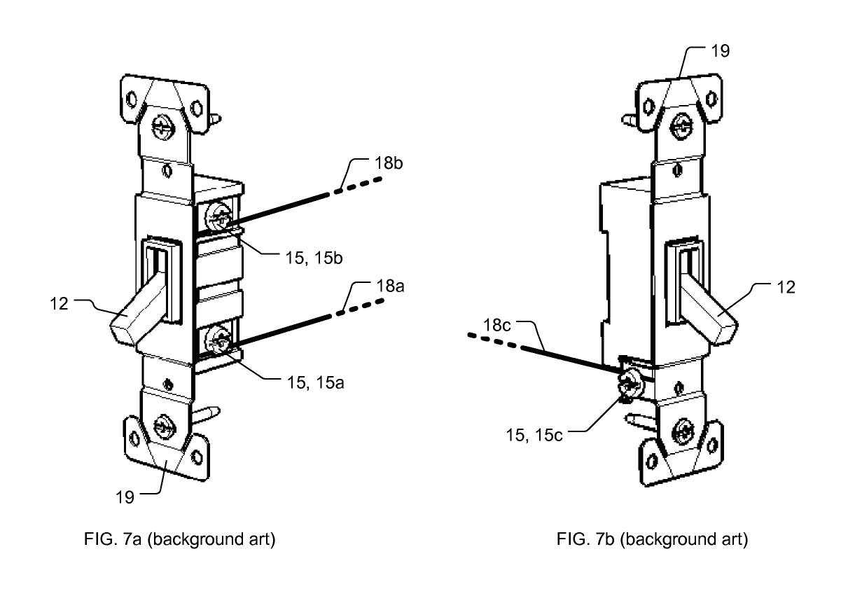

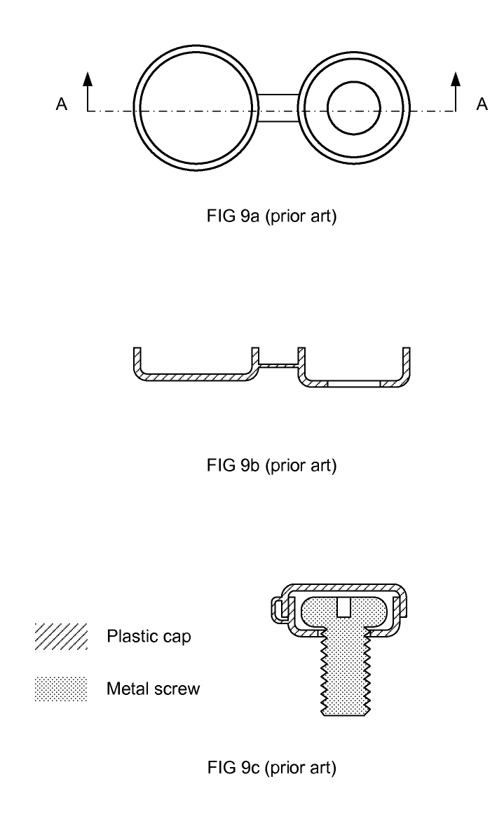

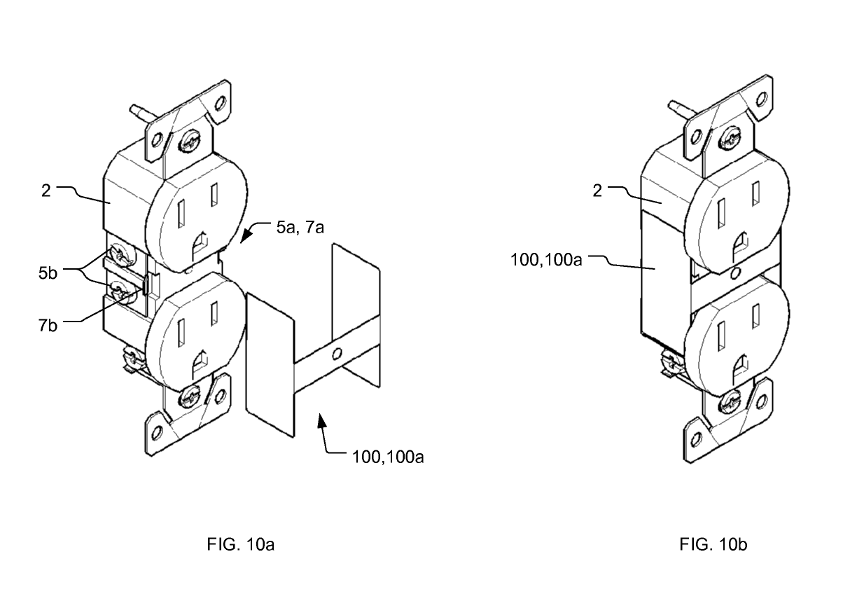

And FIG. 25 shows a front view of yet another variation of the cover of FIGS. 10a-b installed on a receptacle.

In the various figures of the drawings, like references are often used to denote like or similar elements or steps.

### DETAILED DESCRIPTION OF THE INVENTION

A preferred embodiment of the present invention is an electrical shock and burn protection system. As illustrated in the various drawings herein, and particularly in the views of FIGS. 10a-b, 11a-b, 12a-b, 13a-b, 14, and 15 preferred embodiments of the invention are depicted by the general reference character 100.

Briefly, the present invention may be embodied as a safety cover 100 that reduces dangerous access to exposed high potential at electricity distribution endpoints, controls, and sub distribution systems. The cover 100 can take either of two general forms, which are stylistically here termed the “full butterfly” style and the “half butterfly” style. When completely formed for use, the full butterfly style resembles an “H” wrapped into a channel (an “H-channel) in three dimensions. When completely formed for use, the half butterfly style resembles an “U” wrapped into a channel (an “U-channel) in three dimensions. Within these two major styles, many sub-variations of the cover 100 are further possible, as now described.

FIGS. 10a-b depict an example of the full butterfly style cover 100a, specifically a type designed for aftermarket mounting on a receptacle 2. FIG. 10a shows the cover 100a separate from the receptacle 2 and FIG. 10b shows the cover 100a installed on the receptacle 2. As can be appreciated by comparing FIGS. 10a-b, the hot screws 5a, the neutral screws 5b, the hot bond tab 7a, and the neutral bond tab 7b are all protected by the cover 100a.

Note, the receptacle 2 can be defined as having four sides or faces, left right, front, and back. The cover 100a is depicted as covering the left side, crossing the front face, and covering the right side of the receptacle 2. This is most efficient at protecting against a typical scenario where a child pokes at the front most sections of a receptacle 2.

There is no major physical reason why the cover 100a could not alternately cover the left side, cross the back face, and cover the right side of the receptacle 2. This would be less efficient at protection. This might also require changing dimensions of the cover 100a to instead match the back side of the receptacle 2.

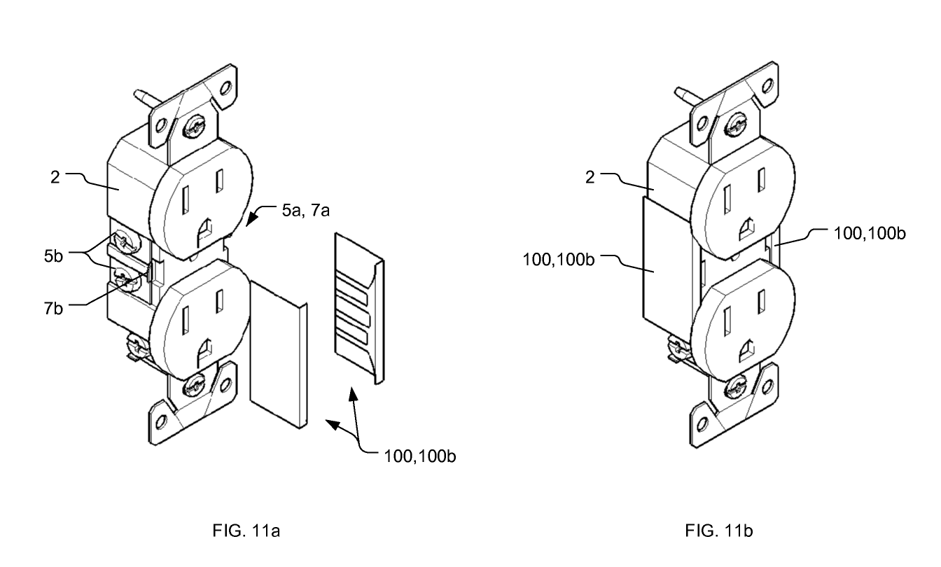

FIGS. 11a-b depict an example of the half butterfly style cover 100b, specifically a type designed for aftermarket mounting on a receptacle 2. Two of the covers 100b are shown being used here. FIG. 11a shows the covers 100b separate from the receptacle 2 and FIG. 11b shows the covers 100b installed on the receptacle 2. As can be appreciated by comparing FIGS. 11a-b, the hot screws 5a, the neutral screws 5b, the hot bond tab 7a, and the neutral bond tab 7b are all protected by use of the two covers 100b. In theory only a single cover 100b could be used on the hot side of the receptacle 2 but, for reasons already described, protecting both sides of the receptacle 2 is safest.

Note, the receptacle 2 can again be defined as having four sides or faces, left right, front, and back. The covers 100b in FIG. 11a are show being installed front to back. This is most efficient at protecting against a typical scenario where a child pokes at the front most sections of a receptacle 2. However, there is no major physical reason why the covers 100b could not alternately be installed back to front.

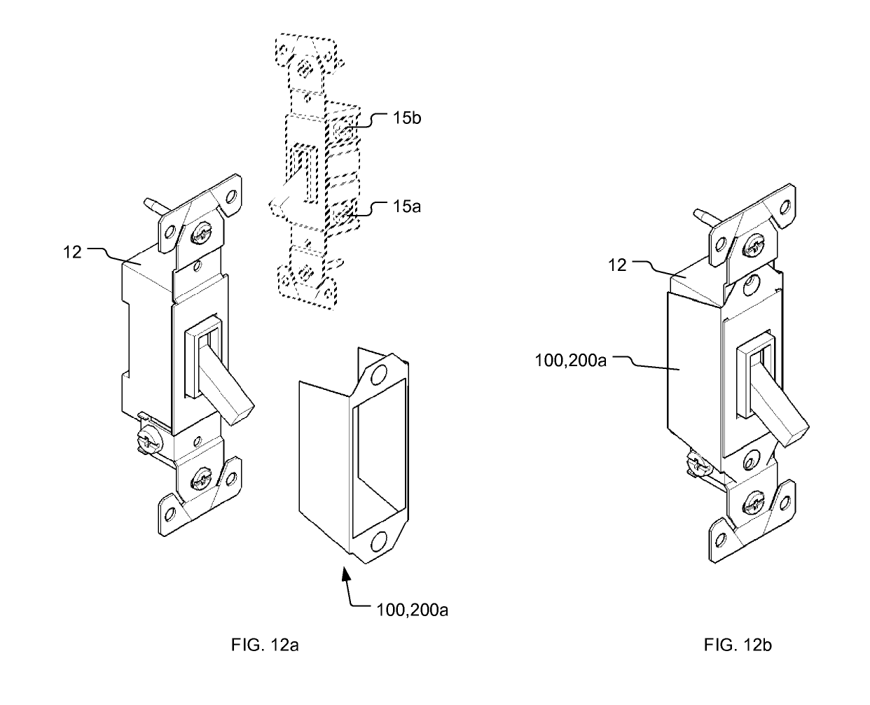

FIGS. 12a-b depict an example of the full butterfly style cover 200a, specifically a type designed for aftermarket mounting on a switch 12. FIG. 12a shows the cover 200a separate from the switch 12 and FIG. 12b shows the cover 200a installed on the switch 12. It can be appreciated by comparing FIGS. 12a-b that the hot screw 15a and the switch leg screw 15b are both protected by the cover 200a. Note, the switch 12 depicted here is a simple single-pole type device. If the switch instead were a multi-pole or multi-way type, the full butterfly style cover 200a here would still protect all of the hot and switch leg screws.

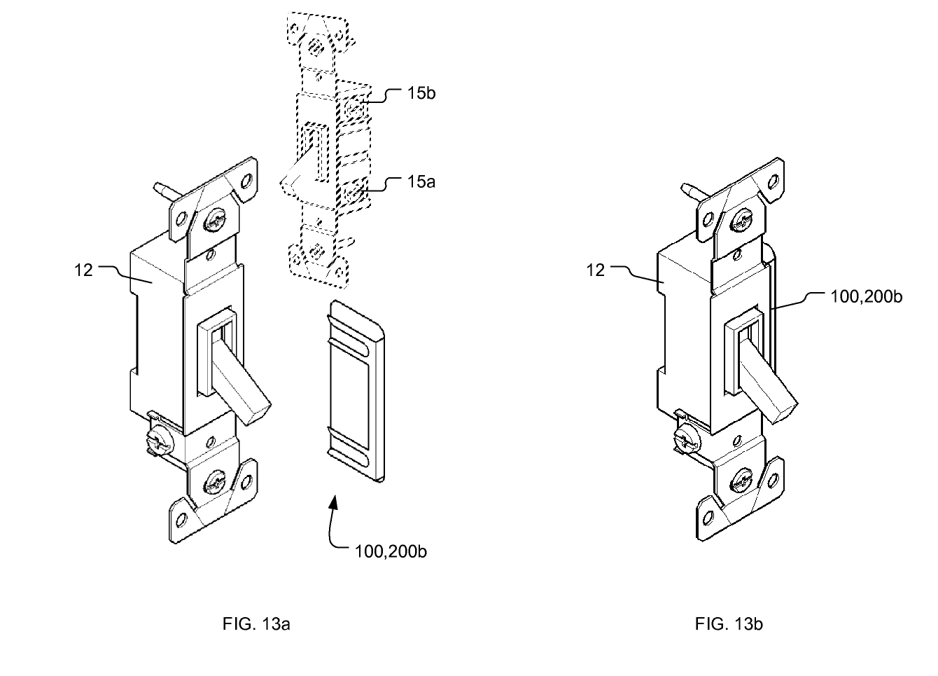

FIGS. 13a-b depict an example of the half butterfly style cover 200b, specifically a type designed for aftermarket mounting on a switch 12. FIG. 13a shows the cover 200b separate from the switch 12 and FIG. 13b shows the cover 200b installed on the switch 12. It can be appreciated by comparing FIGS. 13a-b that the hot screw 15a and the switch leg screw 15b are both protected by use of the cover 200b. Note, only the single cover 200b is sufficient on the simple single-pole type switch 12 depicted. If the switch instead were a multi-pole or multi-way type, then two of the covers 200b could then be used to protect all of the hot and switch leg screws.

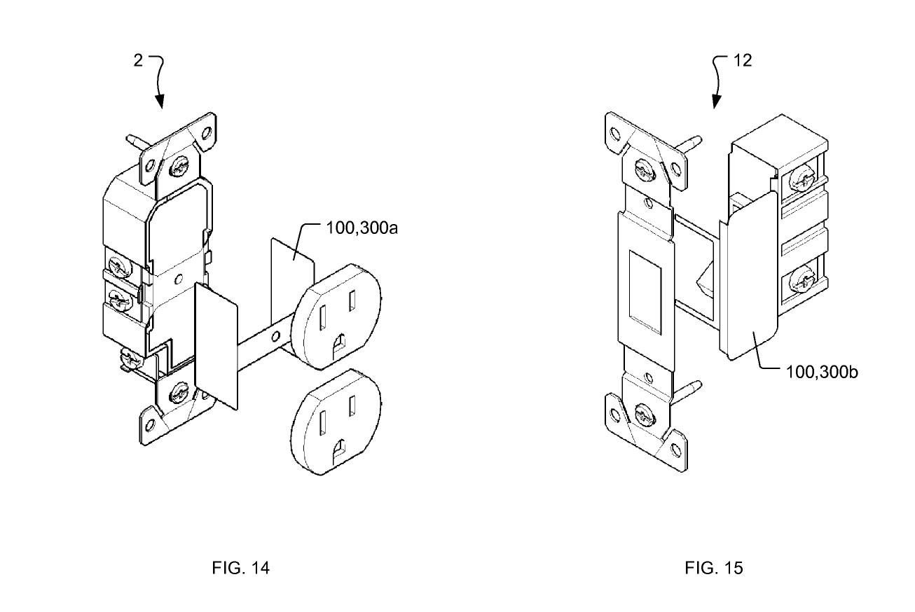

The above covers 100a-b, 200a-b were described as being designed for aftermarket mounting. There is no reason, of course, that original equipment manufacturers (OEMs) of receptacles 2 and switches 12 could not simply include an appropriate cover 100a-b, 200a-b with each device. However, for OEMs a better option is available. FIG. 14 depicts an example of an alternate full butterfly style cover 300a, specifically a type designed for OEM installation as part of a receptacle 2. FIG. 15 depicts an example of an alternate half butterfly style cover 300b, specifically a type designed for OEM installation as part of a switch 12. In both FIGS. 14-15 the covers 300a-b are integrated into the finished manufactured receptacle 2 and switch 12. The mechanism shown here for integration is trapping the covers 300a-b between upper and lower elements of the finished device, but any other manner of integration mechanism may also be true to the spirit of the present invention.

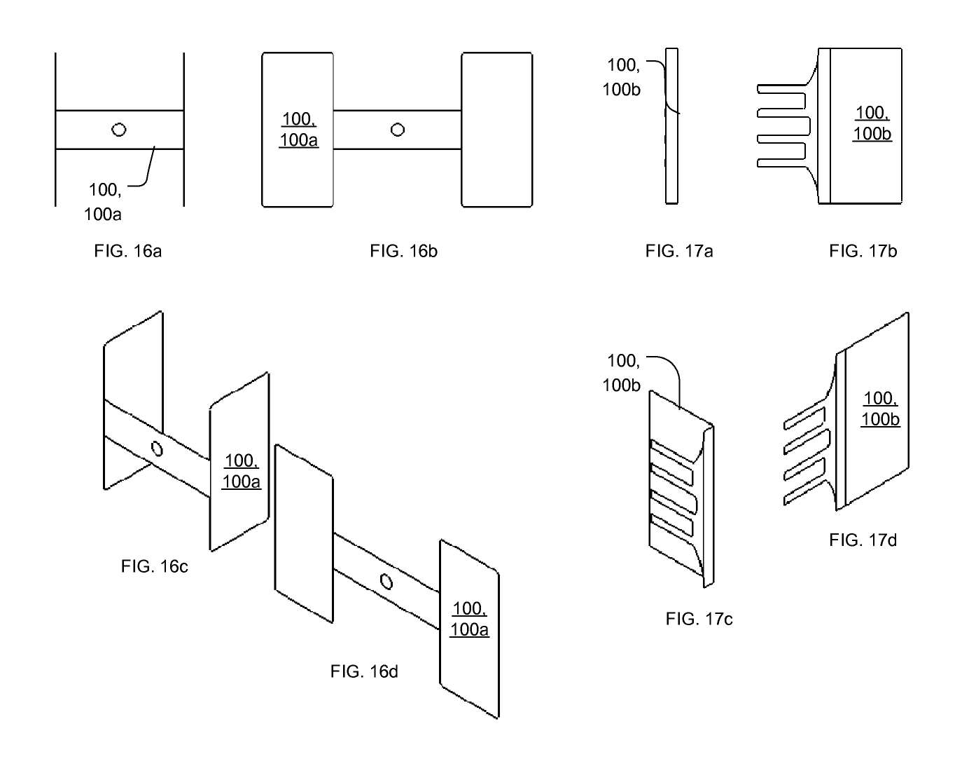

FIGS. 16a-d show the full butterfly style cover 100a of FIGS. 10a-b respectively in a front finished view, a front flat unfinished view, an isometric finished view, and a front isometric unfinished view. Although there are many materials and manufacturing methods that can be used to make the cover 100a, the inventor anticipates that what will most likely be used are plastic material and die stamping from sheet stock with folding and heat applied to shape the cover 100a as can be seen in FIG. 16c.

FIGS. 17a-d show the half butterfly style cover 100b of FIGS. 11a-b respectively in a front finished view, a front flat unfinished view, an isometric finished view, and a front isometric unfinished view. Here as well, the inventor anticipates that similar material and methods will be used to obtain the cover 100b as can be seen in FIG. 17c.

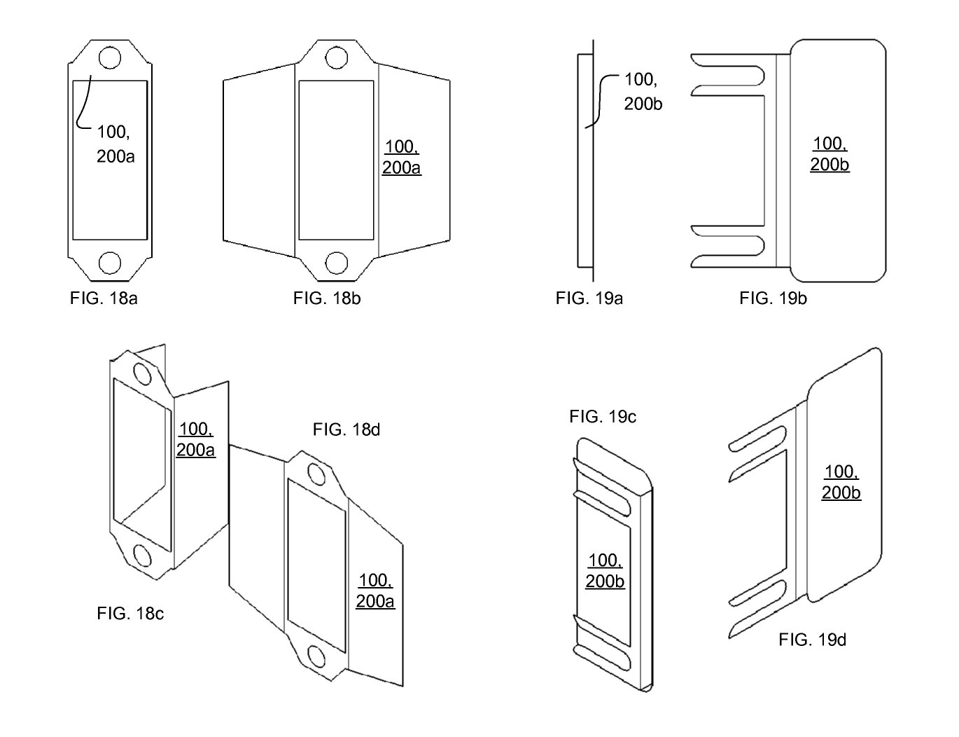

FIGS. 18a-d show the full butterfly style cover 200a of FIGS. 12a-b respectively in a front finished view, a front flat unfinished view, an isometric finished view, and a front isometric unfinished view. Here as well, the inventor anticipates that similar material and methods will be used to obtain the cover 200a as can be seen in FIG. 18c.

FIGS. 19a-d show the half butterfly style cover 200b of FIGS. 13a-b respectively in a front finished view, a front flat unfinished view, an isometric finished view, and a front isometric unfinished view. Here as well, the inventor anticipates that similar material and methods will be used to obtain the cover 200b as can be seen in FIG. 19c.

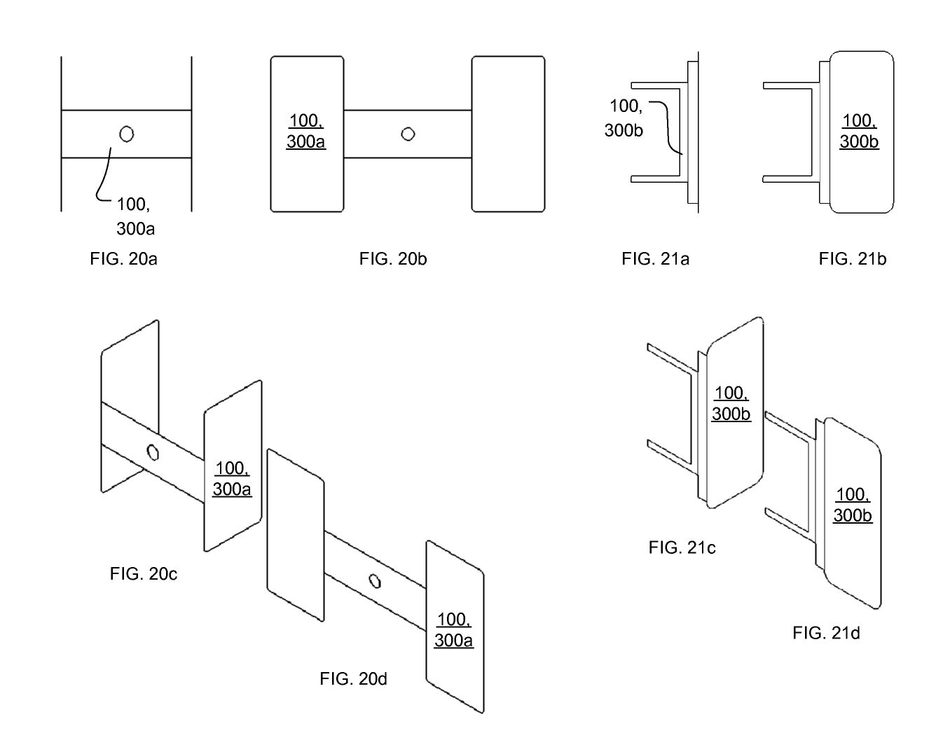

FIGS. 20a-d show the full butterfly style cover 300a of FIG. 14 respectively in a front finished view, a front flat unfinished view, an isometric finished view, and a front isometric unfinished view. Here as well, the inventor anticipates that similar material and methods will be used to obtain the cover 300a as can be seen in FIG. 20c. With reference briefly also to FIGS. 10a-b and 14, the difference between the aftermarket design cover 100a and the OEM design cover 300a is that the center section of the cover 300a is wider, so that that section is captured between the front and rear components of the receptacle 2 during assembly.

FIGS. 21a-d show the half butterfly style cover 300b of FIG. 15 respectively in a front finished view, a front flat unfinished view, an isometric finished view, and a front isometric unfinished view. And here again, the inventor anticipates that similar material and methods will be used to obtain the cover 300b as can be seen in FIG. 21c. With reference briefly also to FIGS. 13a-b and 15, the difference between the aftermarket design cover 200b and the OEM design cover 300b is that the left sections of the cover 300b are folded at a right angle to the right section, so that the leftmost parts of the two left sections are captured between the front and rear components of the switch 12 during assembly.

In general, this discussion has so far covered varieties of the cover 100, such as the full butterfly style embodiments of the covers 100a, 200a, 300a and the half butterfly style embodiments of the covers 100b, 200b, 300b. This discussion has so far also covered varieties of the cover 100 for use with both receptacles 2 and switches 12. Those of skill in the art should now be able to appreciate that embodiments of the cover 100 can be adapted in straightforward manner for use with many other electrical devices.

This discussion now turns to a few options and minor points with respect to the inventive covers 100. The embodiments of the aftermarket design, full butterfly style covers 100a, 200a may be awkward to install. Various options exist, however, to remedy this.

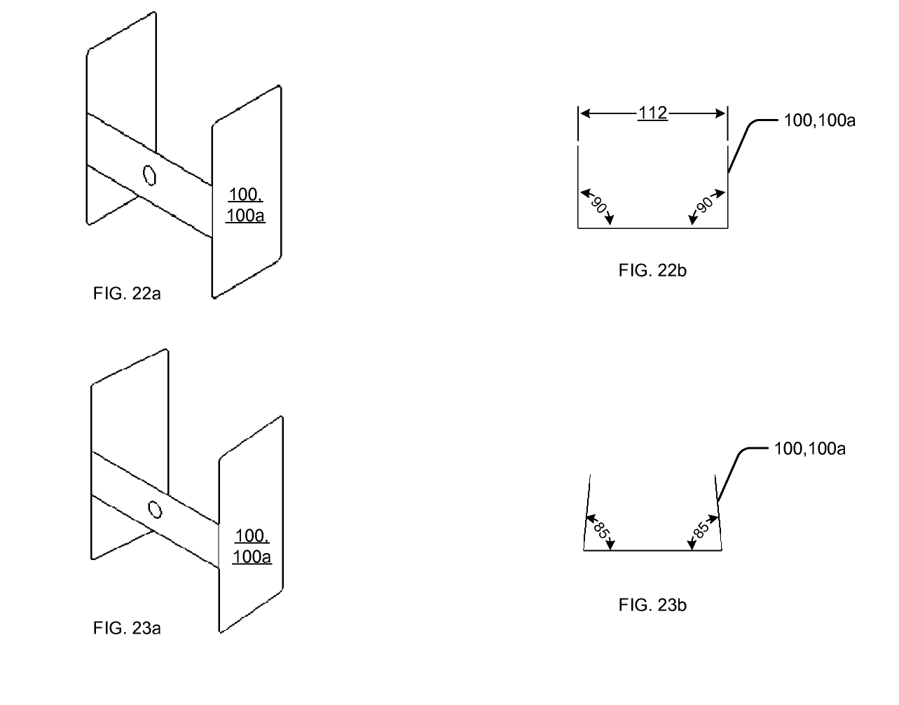

FIGS. 22a-b show the cover 100a in isometric and top views. If the width dimension 112 exceeds the width of the receptacle 2, the cover 100a will be loose and can fall off the receptacle before a cover plate 4 is installed to trap the cover 100a in place. One approach to preventing the cover 100a being loose in this manner is to manufacture the cover 100a with the width dimension 112 equal or slightly smaller than the width of the receptacle 2, so that the cover 100a pinchingly grips onto the receptacle 2.

FIGS. 23a-b show a slight variation of the cover 100a in isometric and top views. In FIGS. 22a-b the side sections of the cover 100a were at right angles to the center section. Here in FIGS. 23a-b the side sections of the cover 100a are folded further, as shown, beyond right angles and in a manner that permits the cover 100a here to also pinchingly grip onto the receptacle 2.

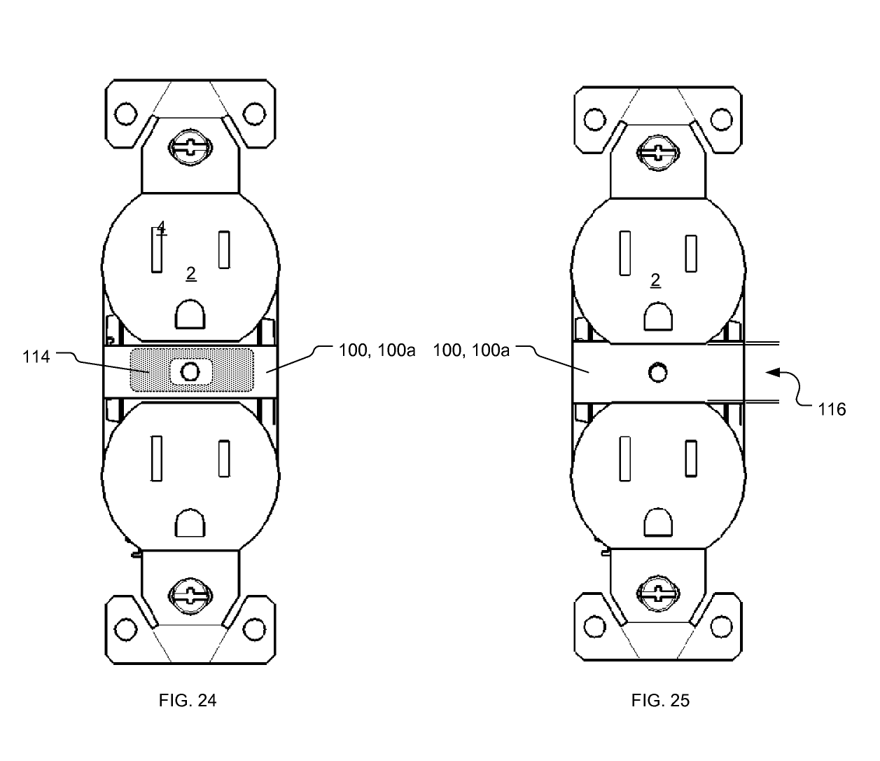

FIG. 24 shows a front view of another variation of the cover 100a installed on a receptacle 2. Here a adhesive region 114 has been provided on the center section of the cover 100a to stick the cover 100a to the receptacle 2 during installation. [Shown here in ghost view, since the adhesive region 114 is on the back side of the cover 1991a as shown.]

FIG. 25 shows a front view of yet another variation of the cover 100a installed on a receptacle 2. Here the center section of the cover 100a has been sized to have an interference fit 116 on the receptacle 2 to snap the cover 100a onto the receptacle 2 during installation.

The same principles applicable to the cover 100a here are also applicable to the cover 200a. In contrast, the half butterfly style covers 100b, 200b are held on by engagement with the hot screws 5a, the neutral screws 5b or the hot screw 15a and switch leg screw 15b. Furthermore, this is so regardless of whether these screws 5a-b, 15a-b are tightened or not. Of course, the OEM design covers 300a-b are positively held due to the manner of manufacturer.

While various embodiments have been described above, it should be understood that they have been presented by way of example only, and that the breadth and scope of the invention should not be limited by any of the above described exemplary embodiments, but should instead be defined only in accordance with the following claims and their equivalents.

For the above, and other, reasons, it is expected that the covers 100 of the present invention will have widespread industrial applicability and it is therefore expected that the commercial utility of the present invention will be extensive and long lasting.

What is claimed is:

1. A cover for an electrical connector device of the type having exposed conductive screws that may have an electrical potential, wherein the screws have screw heads nominally defining at least one screws head plane, comprising:
an electrically insulating shroud retainedly fixable to the device to be planarly disposed over the at least one screws head plane such that the screws are not exposed.

2. The cover of claim 1, wherein the connector device is a duplex receptacle, as termed in the home building trade.

3. The cover of claim 1, wherein the connector device is a wall switch, as termed in the home building trade.

4. The cover of claim 1, wherein:
the connector device is defined to have a left side, a front face, a back face, and a right side;
said left side and said right sides have opposed sets of the screws each having a respective head plane; and
said shroud is a unitary piece that covers the screws and the head plane of said left side, that crosses over a portion of said front face or said back face, and that covers the screws and the head plane of said right side.

5. The cover of claim 4, wherein said unitary piece removably attaches to said front face or said back face of the connector device.

6. The cover of claim 4, wherein:
said unitary piece is attached to said front face or said back face as part of original manufacturer of the connector device.

7. The cover of claim 4, wherein:
said unitary piece has three sections defined by two right angle folds such that said shroud covers the screws and the head plane of said left side and covers the screws and the head plane of said right side by enveloping the electrical connector device within said three sections.

8. The cover of claim 1, wherein:
the connector device is defined to have a left side and a right side;
said left side and said right sides have opposed sets of the screws each having a respective head plane; and
said shroud is two pieces wherein one said piece covers the screws and the head plane of said left side and another said piece covers the screws and the head plane of said right side.

9. The cover of claim 8, wherein said pieces removably attach to said left side and said right side of the connector device.

10. The cover of claim 8, wherein said pieces are attached to said left side and said right side as part of original manufacturer of the connector device.

11. The cover of claim 8, wherein each said piece has two major sections defined by a fold to envelope the screws and the head plane of a respective said left side or right side of the electrical connector device within said two major sections

12. The cover of claim 1, wherein:
the connector device is defined to have a right side;
said right side has the screws and the head plane; and
said shroud is one piece that covers the screws and the head plane of said right side.

13. The cover of claim 12, wherein said piece removably attaches to said right side of the connector device.

14. The cover of claim 12, wherein said piece is attached to said right side as part of original manufacturer of the connector device.

15. The cover of claim 12, wherein said piece has two major sections defined by a fold to envelope the screws and the head plane of a respective said left side or right side of the electrical connector device within said two major sections

16. A method for protecting against shock or burn at an electrical connector device of the type having exposed conductive screws that may have an electrical potential, wherein the screws have screw heads nominally defining at least one screws head plane, the method comprising:
defining the device to have a left side, a front face, a back face, and a right side;
forming an electrically insulating shroud having three sections defined by two right angle folds such that said shroud can cover the screws and the head plane of said left side and cover the screws and the head plane of said right side by enveloping the electrical connector device within said three sections; and
retainedly fixable attaching said shroud to the device to be planarly disposed over the at least one screws head plane such that the screws are not exposed.

17. A method for protecting against shock or burn at an electrical connector device of the type having exposed conductive screws that may have an electrical potential, wherein the screws have screw heads nominally defining a screws head plane, the method comprising:
defining the device to have a left side, a front face, a back face, and a right side, wherein the screws head plane is at said right side;
forming an electrically insulating shroud having two major sections defined by a fold such that said shroud can cover the screws and the head plane of said right side; and
retainedly fixable attaching said shroud to the device to be planarly disposed over the screws head plane such that the screws are not exposed.
